(19) United States
(12) Patent Application Publication
(10) Pub. No.: US 2007/0092758 A1
(43) Pub. Date: Apr. 26, 2007

(54) Dispersant having silane head and phosphor paste composition comprising the same

(76) Inventors: Eun Sung Lee, Seoul (KR); Jae Young Choi, Suwon-Si (KR); Don Ik Lee, Icheon-Si (KR); Seon Mi Yoon, Yongin-Si (KR)

Correspondence Address: CANTOR COLBURN, LLP, 55 GRIFFIN ROAD SOUTH, BLOOMFIELD, CT, 06002, US

(21) Appl. No.: 11/440,248

(22) Filed: May 24, 2006

(30) Foreign Application Priority Data
Oct. 20, 2005 (KR) 10-2005-0099090

(51) Int. Cl. B32B 9/00; C07F 7/08

(52) U.S. Cl. 428/690; 556/445; 556/446

(57) ABSTRACT

A dispersant having a silane head, and a phosphor paste composition including a phosphor, organic binder, and the silane dispersant are disclosed. The silane dispersant of this invention can greatly increase dispersion efficiency of a phosphor in a curable binder resin system. Thus, when the dispersant is used upon fabrication of a white light emitting diode, the resulting light emitting diode can have high luminance.

This application claims priority to Korean Patent Application No. 2005-99090, filed on Oct. 20, 2005, and all the benefits accruing therefrom under 35 U.S.C. § 119(a), the contents of which are herein incorporated by reference in its entirety.

### BACKGROUND OF THE INVENTION

1. Field of the Invention

The present invention relates, generally, to use of a dispersant having a silane head in a phosphor paste composition comprising the same, and more particularly, to a dispersant having a silane head, which can be efficiently coupled with a phosphor by virtue of the silane head, thereby increasing dispersion efficiency of a curable resin system, and to a phosphor paste composition comprising such a dispersant.

2. Description of the Related Art

In general, light emitting devices, such as laser diodes or light emitting diodes (LEDs), have emission wavelengths defined only within predetermined regions, and have limited ability to emit light at various wavelengths. Thus, in the case where a light source having various wavelengths is required, a phosphor is applied to an LED chip in order to obtain light at a desired wavelength. For example, with the aim of obtaining a white light emitting device, a phosphor emitting yellow light is applied an LED chip emitting blue light such that blue light is combined with yellow light to provide white light.

The white LED is being considered as an inexpensive alternative for paper-thin light sources, backlight units of liquid crystal displays, display parts of notebook computers, dome lights of automobiles, and illumination sources.

For fabrication of the white LED, the phosphor is mixed with a curable binder resin, such as epoxy resin, polydimethylsiloxane (PDMS), acrylic resin, and the like, after which the mixture thus obtained is applied to an LED chip to encapsulate it, and then cured. In this case, the phosphor may undesirably precipitate prior to application of the mixture due to the difference in specific gravity between the phosphor and the curable binder resin, and thus an excess amount of the phosphor may need to be used. Consequently, the a decrease in total luminous efficiency of the white LED can occur, that is attributable to the use of excess phosphor.

Therefore, a dispersant may be added in order to increase the dispersibility of the phosphor. However, the same dispersant may exhibit different behaviors depending on the type of binder resin with which it is used. For example, in the case where a non-reacting dispersant (e.g., a polyethylene glycol monoether or polypropylene-glycol monoether) is used together with a burn-out type binder, such as polyvinylalcohol, polyvinylbromide, ethylene chloride, etc., the combination can manifest improved dispersibility when compared with a composition without dispersant. However, where such a dispersant is used together with a curable binder resin for use in the fabrication of white LEDs, it may seldom or never exhibit improved dispersibility when compared with a composition without dispersant.

FIG. 2 is a graph showing viscosity varying with an increase in shear rate of each of a dispersion (▪) obtained by dispersing BaMgAl₁₀O₁₇:Eu,Mn as a green phosphor in a solvent mixture composed of ethylcellulose, terpineol, and butylcarbitol acetate, a mixture (•) obtained by adding a conventional carboxyl ester-based dispersant to the above dispersion, a dispersion (▴) obtained by dispersing the above phosphor in PDMS and epoxy resin, and a mixture (▾) obtained by mixing the above phosphor, PDMS, epoxy resin, and carboxyl ester-based dispersant together. As shown in FIG. 2, the dispersant functions to decrease the viscosity of the dispersion using the solvent mixture comprising terpineol and butylcarbitol acetate, and conversely to increase the viscosity in the curable resin system such as PDMS and epoxy resin.

Thus, a dispersant that is effective in dispersing a phosphor in a curable resin upon fabrication of white LEDs is desirable.

### SUMMARY OF THE INVENTION

Accordingly, the present invention has been made keeping in mind the above problems occurring in the related art. An object of the present invention is to provide a dispersant having a silane head, where the dispersant is capable of increasing dispersibility a phosphor in a curable organic binder.

Another object of the present invention is to provide a phosphor paste composition useful for the fabrication of a white LED having high luminance.

In order to achieve the above objects, the present invention provides a dispersant having a silane head as represented by Formula 1, Formula 4, or Formula 5 below:

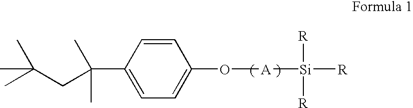

wherein R is a methoxy group or an ethoxy group, and A is represented by Formula 2 or Formula 3 below:

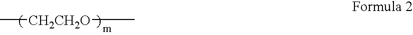

wherein m is an integer from 1 to 20;

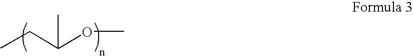

wherein n is an integer from 1 to 20;

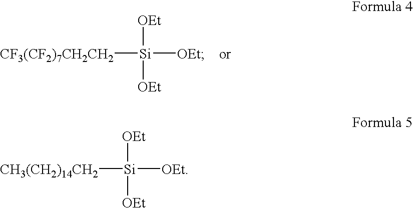

In addition, the present invention provides a phosphor paste composition comprising a binder solution, a phosphor, and the dispersant having a silane head. The phosphor paste composition of the present invention may be prepared by adding the silane dispersant to the organic binder and further adding the phosphor powder.

Examples of the organic binder usable in the phosphor paste composition include, but are not limited to, epoxy resin, acrylic resin, PDMS resin, phenol resin, polyurethane resin, amino resin, or polyester resin. In an embodiment, the organic binder is curable.

In addition, the present invention provides a thin film and a light emitting device, fabricated using the phosphor paste composition according to a typical process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a ¹H-NMR spectrum of a silane dispersant of Formula 5;

FIG. 2 is a graph showing the dispersion effect of a conventional dispersant on a curable resin;

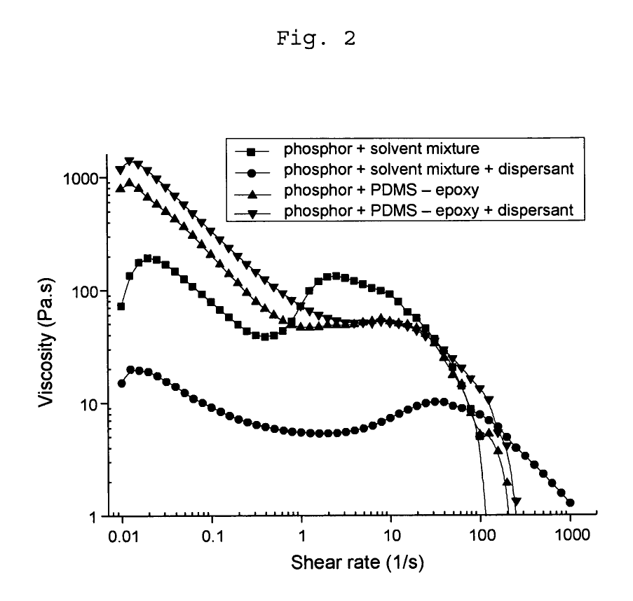

FIG. 3 is a graph showing the variation in viscosity of each of phosphor paste compositions prepared in Example 1 and Comparative Examples 1 to 3 when the shear rate is increased;

FIG. 4 is a graph showing the variation in viscosity of each of the phosphor paste compositions prepared in Example 1 and Comparative Example 1 when the amount of phosphor is increased;

FIG. 5 is a graph showing the variation in viscosity of each of the phosphor paste compositions prepared in Examples 2 and 3 when the shear rate is increased; and

FIG. 6 is a graph showing the variation in viscosity of each of the phosphor paste compositions prepared in Examples 4 and 5 when the shear rate is increased.

### DESCRIPTION OF THE PREFERRED EMBODIMENTS

Hereinafter, a detailed description will be given of the present invention, with reference to the appended drawings.

It will be understood in the following disclosure of the present invention, that as used herein, the term “and/or” includes any and all combinations of one or more of the associated listed items.

Also as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The compositions disclosed herein include a phosphor, an organic binder, and a dispersant. The dispersant of the present invention is a dispersant having a silane head, also referred to herein as a “silane dispersant.” Silane dispersants of use herein are represented by Formula 1, Formula 4, or Formula 5 below:

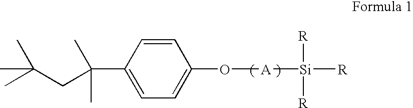

wherein R is a methoxy group or an ethoxy group, and A is represented by Formula 2 or Formula 3 below:

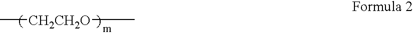

wherein m is an integer from 1 to 20;

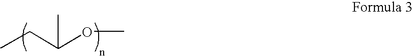

wherein n is an integer from 1 to 20;

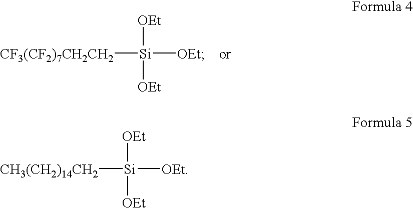

The dispersant of Formula 1 is a silane dispersant having a silicon-based head (also referred to herein as a “silane head”), a hydrophilic block, and hydrophobic block type or hydrophobic tail structure. The dispersant of Formula 4 is a silane dispersant having a fluoroalkyl block type tail structure, and the dispersant of Formula 5 has an alkyl type tail structure.

The dispersant having a silicon-based head is minimally affected by any acid-base interaction that may occur due to the formation of covalent bonds during thermal treatment. The reactivity of the silane head of the dispersant can allow the formation of a covalent bond between the silane dispersant and the phosphor, and/or allow crosslinking between the silane dispersant and the long-chain polymer (i.e., the organic binder) used in the resin layer containing the dispersed phosphor. Thus, the dispersant having a silane head is efficiently coupled with the phosphor, thereby increasing the dispersibility of the phosphor. A composition comprising the reaction product of the phosphor, organic binder, and dispersant having a silane head thus provides improved dispersibility of the phosphor.

Preferable examples of the dispersant of Formula 1 include a silane dispersant having a structure represented by Formula 6 or Formula 7 below:

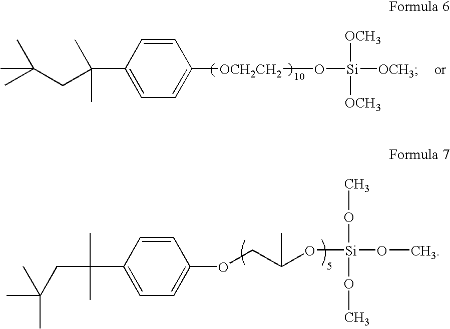

Silane dispersants represented by Formula 1, in which A is ethylene oxide, may be synthesized according to Reaction Scheme 1 below: 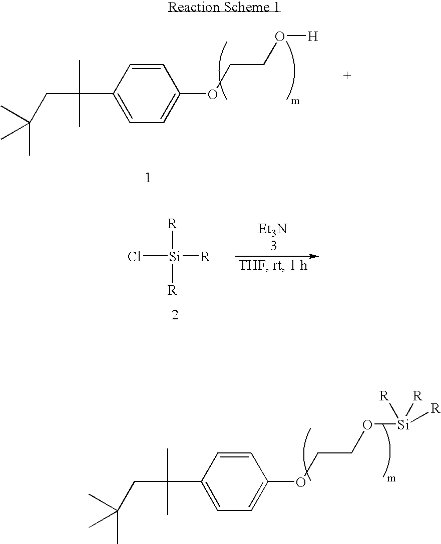
wherein R is a methoxy group or an ethoxy group, and m is an integer from 1 to 20.

The silane dispersants can exhibit excellent dispersion effects upon application to a curable binder resin system. Hence, the silane dispersant may be added as a dispersant to a phosphor paste composition used for the fabrication of white LEDs. In the phosphor paste composition containing the silane dispersant, the silane dispersant is adsorbed onto the surface of the phosphor particles in order to prevent agglomeration between the particles, thereby increasing the packing factor of the phosphor particles in the phosphor paste. As disclosed herein, the term “packing factor”, also referred to in the art as “packing fraction” and “packing density”, represents a measure of the uniformity of distribution and density of the phosphor particles in a layer prepared from the phosphor paste composition. A layer having a low packing factor would have undesirably low optical uniformity and low luminance. A high packing factor is desirable to minimize layer thickness and any defectivity in uniformity and image sharpness. Light emitting devices, such as for example white LEDs, fabricated using the phosphor paste composition can exhibit high luminance.

In an embodiment, the silane dispersant is used to provide a phosphor paste composition. The phosphor paste composition comprises the silane dispersant, an organic binder, and a phosphor. The organic binder and the phosphor constituting the phosphor paste composition include materials that are the same as or similar to those used for a conventional phosphor paste composition, i.e., a phosphor paste composition prepared using non-silane dispersants as disclosed herein. The phosphor paste composition of the present invention may be prepared by adding the silane dispersant to the organic binder and further adding the phosphor powder. The phosphor of a phosphor paste composition prepared by this method has the phosphor dispersed in the organic binder.

The organic binder functions to provide viscosity after being dissolved in a solvent, and to provide bondability after the phosphor paste composition is burned (i.e., thermally treated). Examples of the organic binder useful herein include, but are not limited to, epoxy resin, acrylic resin, PDMS resin, phenol resin, polyurethane resin, amino resin, or polyester resin. Those organic binders that are curable are specifically useful.

As the phosphor used in the phosphor paste composition, any phosphor for a conventional phosphor paste composition may be used. Types and compositions of the phosphor used are not particularly limited. The phosphor used typically includes a blue phosphor, a green phosphor, or a red phosphor.

The red phosphor may include (Y,Gd)BO₃:Eu, Y(V,P)O₄:Eu, (Y,Gd)O₃:Eu, La₂O₂S:Eu³⁺, etc. Of these phosphors, (Y,Gd)BO₃:Eu, having excellent luminance properties, is preferably used.

The green phosphor may include at least one selected from the group consisting of BaMgAl₁₀O₁₇:Eu,Mn, Zn₂SiO₄:Mn, (Zn,A)₂SiO₄:Mn (where A is an alkali earth metal), MgAlxOy:Mn (where x=an integer from 1 to 10, and y=an integer from 1 to 30), LaMgAlxOy:Tb (where x=an integer from 1 to 14, and y=an integer from 8 to 47), ReBO₃:Tb (where Re is at least one rare earth element selected from the group consisting of Sc, Y, La, Ce, and Gd), and (Y,Gd)BO₃:Tb.

The blue phosphor may include at least one selected from the group consisting of Sr(PO₄)₃Cl:Eu²⁺, ZnS:Ag, Cl, CaMgSi₂O₆:Eu, CaWO₄:Pb, and Y₂SiO₅:Eu.

The phosphor paste composition may further include other additives, such as a plasticizer, a leveling agent, an antioxidant, a smoothing agent, an antifoaming agent, etc., in addition to the silane dispersant, within a range that does not retard the properties of the composition. These additives are known to be commercially available by those skilled in the art.

The phosphor paste composition is composed of 40 to 70 wt % of phosphor powder and 0.1 to 3 wt % of the silane dispersant based on the weight of the phosphor powder, with the balance of the binder solution. As such, if the amount of silane dispersant is less than 0.1 wt %, the phosphor is used in an increased amount and sufficient viscosity is difficult to maintain. On the other hand, if the amount of silane dispersant exceeds 3 wt %, the properties of the paste may be deteriorated due to the decrease in amounts of other components.

In the present invention, the use of dispersant having a silane head results in increased dispersibility of the phosphor in the curable binder resin system. Further, the luminance of the LED obtained using such phosphor paste can be increased.

The phosphor paste composition may be used upon the fabrication of light emitting devices, such as, for example, white LEDs. For example, an LED may be fabricated by mounting individual LED chips to lead frames, applying a resin layer comprising the phosphor paste composition having the phosphor dispersed therein on the LED chips, and encapsulating the resin layer, wires and lead frames using a predetermined resin. In another example, a thin film can be formed from the reaction product of a phosphor, an organic binder, and a silane dispersant. The thin film may be formed by contacting the phosphor paste composition to a substrate by coating a known coating method, and curing the applied phosphor paste composition using a thermal treatment.

The light emitting device fabricated using the phosphor paste composition may be variously applied to paper-thin light sources, backlight units of liquid crystal displays, dome lights of automobiles, and illumination sources. The light-emitting device fabricated using the phosphor paste composition has high packing factor, and thus has no UV light leakage and provides high luminance.

A better understanding of the present invention may be obtained in light of the following examples which are set forth to illustrate, but are not to be construed to limit the present invention.

### SYNTHESIS EXAMPLE OF THE SILANE DISPERSANT OF FORMULA 6

A silane dispersant of Formula 6 was synthesized according to Reaction Scheme 2 below:

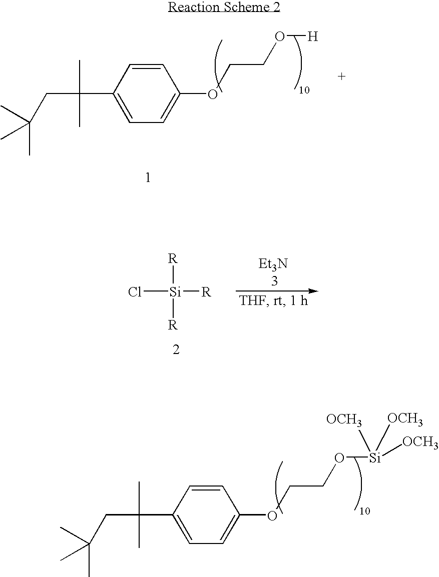

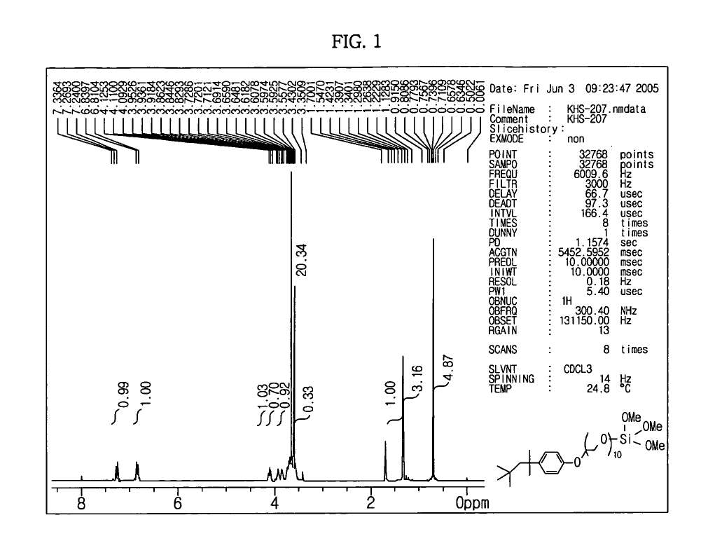

As is apparent from Reaction Scheme 2, the compound 1 was mixed with Et₃N (1.5 molar equivalents) and THF (500 ml) to obtain a mixture, to which the compound 2 (30.5 mmol, 13 g) was then added in droplets. The reaction mixture was stirred for about 1 hour. After the solvent was removed, the solid component was filtered through celite and the filtrate was removed under reduced pressure. The resulting product was purified using column chromatography (MC:MeOH=20:1 v/v), thus obtaining the dispersant having a silane head of Formula 6 in a brown oil phase (yield 96%). The 500 MHz ¹H-NMR spectrum of the silane dispersant thus obtained is shown in FIG. 1.

### EXAMPLE 1

As a phosphor for use in the preparation of a phosphor paste composition, commercially available Sr(PO₄)₃Cl:Eu²⁺ powder (Nemoto Blue, Japan) was used. The phosphor powder was vacuum dried at 130° C. for 24 hours in an atmosphere before being used. The phosphor powder (14 g) was added to PDMS (9.8 g), and then the silane dispersant (0.14 g) obtained in the synthesis example was added thereto, followed by conducting a milling process, thus preparing a phosphor paste composition.

### EXAMPLE 2

A phosphor paste composition was prepared in the same manner as in Example 1, with the exception that the compound of Formula 4 ((Tridecafluoro-1,1,2,2-tetrahydrooctyl) triethoxysilane, Gelest, USA) and BaMgAl₁₀O₁₇:Eu²⁺ were used as the silane dispersant and the phosphor, respectively.

### EXAMPLE 3

A phosphor paste composition was prepared in the same manner as in Example 2, with the exception that the compound of Formula 5 (Hexadecyltriethoxysilane, Gelest, USA) was used as the silane dispersant.

### EXAMPLE 4

A phosphor paste composition was prepared in the same manner as in Example 1, with the exception that the compound of Formula 4 and La₂O₂S:Eu³⁺ were used as the silane dispersant and the phosphor, respectively.

### EXAMPLE 5

A phosphor paste composition was prepared in the same manner as in Example 4, with the exception that the compound of Formula 5 was used as the silane dispersant.

### Comparative Example 1

A phosphor paste composition was prepared in the same manner as in Example 1, with the exception that no dispersant was used.

### Comparative Example 2

A phosphor paste composition was prepared in the same manner as in Example 1, with the exception that commercially available Triton® X100 (TX-100, Sigma-Aldrich, USA) was used as the dispersant.

### Comparative Example 3

A phosphor paste composition was prepared in the same manner as in Example 1, with the exception that commercially available BYK111 (Disperbyk® 111, BYK-Chemie, Germany) was used as the dispersant.

### Experimental Example 1

### Evaluation of Viscosity Varying With Shear Rate of Dispersant

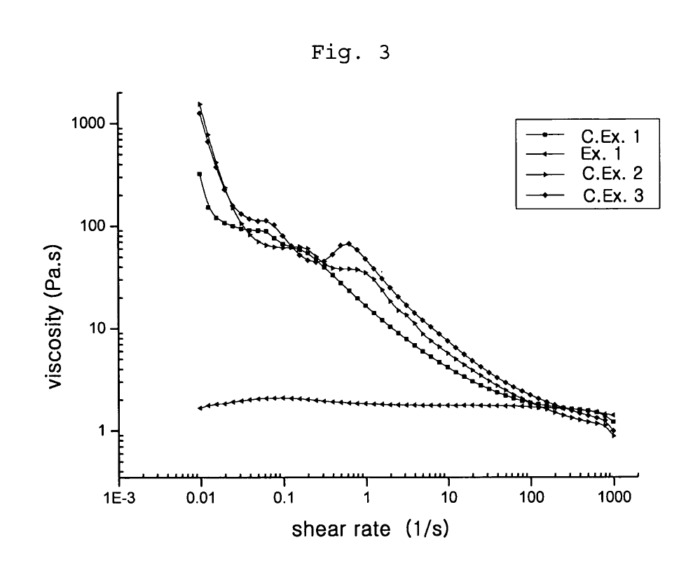

While increasing the shear rate of each of the phosphor paste compositions obtained in Example 1 and Comparative Examples 1-3, variation in the viscosity was observed. The results are shown in FIG. 3.

As such, the viscosity varying with the shear rate was measured with a viscometer (AR2000, Thermal Analysis, USA) under conditions of a measurement temperature of 24.5-25.5° C. and a measurement time period of 30 sec using a #14 spindle.

As is apparent from FIG. 3, the composition prepared without the use of the dispersant (Comparative Example 1) and compositions prepared using conventional dispersants (Comparative Examples 2 and 3) had an increase in viscosity in proportion to the increase in the shear rate. However, the viscosity of the phosphor paste composition of Example 1 prepared using the silane dispersant of the present invention was drastically decreased in proportion to the increase in the shear rate. Therefore, where the silane dispersant was applied to the phosphor and used with a curable resin system such as PDMS, dispersibility was confirmed to have greatly increased.

### Experimental Example 2

### Evaluation of Viscosity Varying with Amount of Phosphor

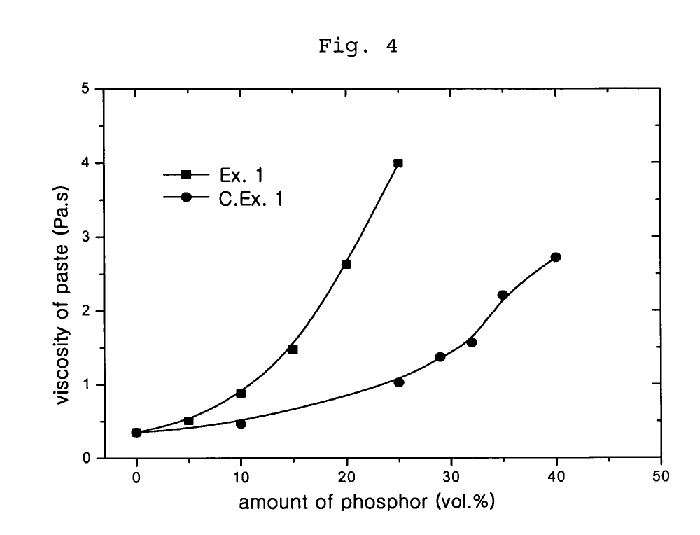

To the resin having the same silane dispersant as that used in Example 1, the same phosphor powder as that used in Example 1 was added to prepare a phosphor paste composition. In this case, while increasing the amount of phosphor, variation in the viscosity of the phosphor paste composition with the amount of phosphor was measured. The results are shown in FIG. 4. The viscosity was measured in the same manner as in Experimental Example 1.

For comparison, a phosphor paste composition was prepared without the use of a dispersant as in Comparative Example 1, and the viscosity thereof varying with the amount of phosphor was measured. The results are also shown in FIG. 4.

As shown in FIG. 4, in Example 1 using a dispersant having a silane head according to the present invention, the phosphor was used in an amount of about 18 vol % until the viscosity reached 2 Pa-s. However, in Comparative Example 1, without the use of the dispersant, the amount of phosphor was increased to about 36 vol %. From this result, the phosphor was confirmed to be dispersed in the phosphor paste composition in a relatively small amount when preparing the phosphor paste composition using the silane dispersant.

### Experimental Example 3

### Evaluation of Viscosity Varying with Shear Rate of Silane Dispersant of Formula 4

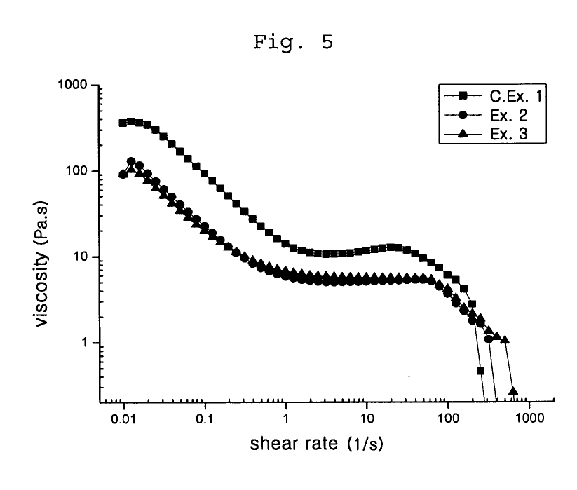

While increasing the shear rate of each of the phosphor paste compositions obtained in Examples 2 and 3 and Comparative Example 1, variation in the viscosity was observed. The results are shown in FIG. 5. The viscosity was measured in the same manner as in Experimental Example 1.

As shown in FIG. 5, the viscosity of each of the phosphor paste compositions of Examples 2 and 3 prepared using the silane dispersant drastically decreased with an increase in shear rate, compared to that of the composition of Comparative Example 1. Thereby, in the case where the silane dispersant was applied to the curable resin system such as PDMS, dispersibility was confirmed to have greatly increased.

### Experimental Example 4

### Evaluation of Viscosity Varying with Shear Rate of Silane Dispersant of Formula 5

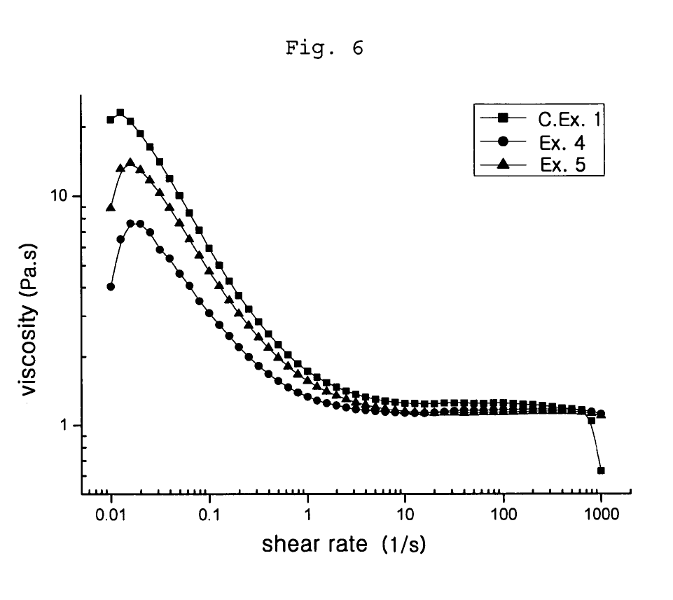

While increasing the shear rate of each of the phosphor paste compositions obtained in Examples 4 and 5 and Comparative Example 1, variation in the viscosity was observed. The results are shown in FIG. 6. The viscosity was measured in the same manner as in Experimental Example 1.

As shown in FIG. 6, the viscosity of each of the phosphor paste compositions of Examples 4 and 5 prepared using the silane dispersant drastically decreased with an increase in shear rate, compared to that of the composition of Comparative Example 1. Thereby, in the case where the silane dispersant was applied to the curable resin system such as PDMS, dispersibility was confirmed to have greatly increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, although the silane dispersant exhibits excellent dispersion effects in a curable binder resin system, the silane dispersants may also be used to prepare phosphor paste compositions other than those of the curable binder resin system disclosed herein.

As previously described herein, the present invention provides a dispersant having a silane head and a phosphor paste composition comprising such a silane dispersant. When the dispersant having a silane head is added to a curable binder resin system, it can greatly increase dispersibility of the phosphor. Accordingly, a light-emitting device fabricated using the phosphor paste composition including the dispersant having a silane head has high packing factor, and therefore has low UV light leakage and high luminance. Such phosphor paste compositions can therefore provide a thin film that covers a large area (i.e., greater than 10 cm×10 cm), and that has excellent uniformity.

In particular, the phosphor paste composition can be used for the fabrication of a white LED. As such, since the phosphor does not precipitate and is efficiently dispersed, it need only be used in a minimum effective amount. Thereby, a problem of low luminosity due to unnecessary phosphor can be overcome, therefore realizing maximum luminous efficiency per unit of phosphor used.

What is claimed is:

1. A dispersant having a silane head, represented by: 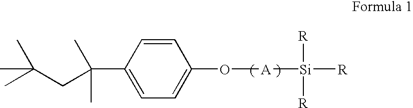
wherein R is a methoxy group or an ethoxy group, and A is represented by Formula 2 or Formula 3 below 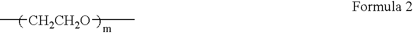
wherein m is an integer from 1 to 20, or 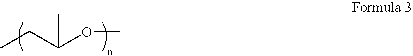
wherein n is an integer from 1 to 20.

2. The dispersant as set forth in claim 1, wherein the dispersant has a structure represented by Formula 6 or Formula 7 below:

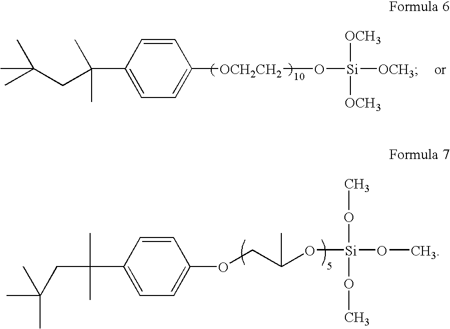

3. A phosphor paste composition, comprising:
an organic binder,
a phosphor, and
a dispersant having a silane head, represented by: 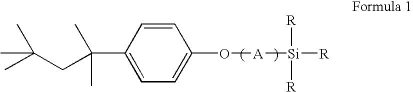
wherein R is a methoxy group or an ethoxy group, and
A is represented by Formula 2 or Formula 3 below: 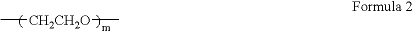
wherein m is an integer from 1 to 20, or 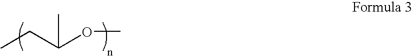
wherein n is an integer from 1 to 20;

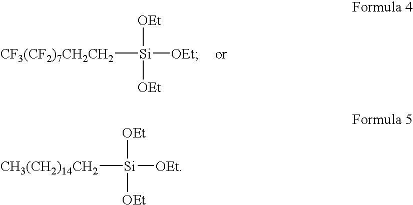

4. The phosphor paste composition as set forth in claim 3, which comprises 40 to 70 wt % of phosphor powder, and 0.1 to 3 wt % of the dispersant based on weight of the phosphor powder, with a balance of the organic binder.

5. The phosphor paste composition as set forth in claim 3, wherein the organic binder is selected from the group consisting of epoxy resin, acrylic resin, polydimethylsiloxane resin, phenol resin, polyurethane resin, amino resin, and polyester resin.

6. The phosphor paste composition as set forth in claim 5, wherein the organic binder is curable.

7. The phosphor paste composition as set forth in claim 3, wherein the phosphor comprises at least one selected from the group consisting of (Y,Gd)BO₃:EU, Y(V,P)O₄:Eu, (Y,Gd)O₃:EU, La₂O₂S:Eu³⁺, BaMgAl₁₀O₁₇:Eu,Mn, Zn₂SiO₄:Mn, (Zn,A)₂SiO₄:Mn (where A is alkali earth metal), MgAlxOy:Mn (where x=an integer from 1 to 10, and y=an integer from 1 to 30), LaMgAlxOy:Tb (where x=an integer from 1 to 14, and y=an integer from 8 to 47), ReBO₃:Tb (where Re is at least one rare earth element selected from the group consisting of Sc, Y, La, Ce, and Gd), (Y,Gd)BO₃:Tb, Sr(PO₄)₃Cl:Eu²⁺, ZnS:Ag, Cl, CaMgSi₂O₆:Eu, CaWO₄:Pb, and Y₂SiO₅:Eu.

8. A light emitting device, comprising a thin film manufactured using the phosphor paste composition of claim 3.

9. The light emitting device as set forth in claim 8, wherein the light emitting device is a white light emitting diode.

10. A method of preparing a phosphor paste composition comprising:
combining
an organic binder, and
a dispersant having a silane head, represented by: 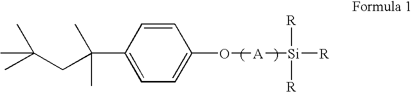
wherein R is a methoxy group or an ethoxy group, and
A is represented by Formula 2 or Formula 3 below: 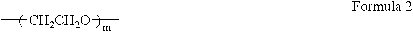
wherein m is an integer from 1 to 20, or 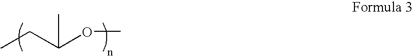
wherein n is an integer from 1 to 20, 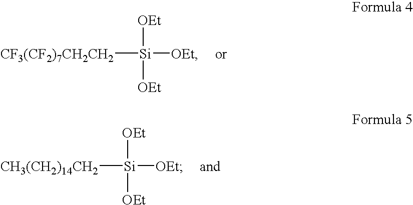
adding a phosphor.

11. The method of claim 10 wherein the phosphor is dispersed in the organic binder.

12. A phosphor paste composition prepared by the method of claim 10.
